(19) United States
(12) Patent Application Publication
(10) Pub. No.: US 2026/0204094 A1
(43) Pub. Date: Jul. 16, 2026

(54) SYSTEM AND METHOD FOR AUTOMATICALLY ADJUSTING ON-SCREEN DISPLAY SETTINGS BASED ON DETECTED FACIAL PATTERNS OF A USER BY A VISUAL SENSOR

(71) Applicant: Dell Products LP, Round Rock, TX (US)

(72) Inventors: Tat Luat Nguyen, Singapore (SG); Yao-Te Peng, Singapore (SG); Loo Shing Tan, Singapore (SG)

(73) Assignee: Dell Products LP, Round Rock, TX (US)

(21) Appl. No.: 19/025,635

(22) Filed: Jan. 16, 2025

(51) Int. Cl. G06V 40/16; G06F 9/445

(52) U.S. Cl. CPC G06V 40/172; G06F 9/4451; G06V 40/165

(57) ABSTRACT

A standalone digital display device that includes a visual sensor to capture images of a user's face and video scaler hardware controller executing a facial detection module to detect facial patterns of a user's face detected in front of the standalone digital display device in the captured images. The video scaler hardware controller to access the scaler storage device on the standalone display to determine if the detected facial patterns of the user's face match a facial pattern stored on the scaler storage device among a plurality of stored facial patterns. The video scaler hardware controller executes computer-readable program code of a profile bridging firmware module to, when a matching facial pattern is found, automatically apply user-selected on-screen display settings associated with the matched facial pattern independently from an operatively coupled information handling system to video data received from the operatively coupled information handling system for display of images.

### FIELD OF THE DISCLOSURE

The present disclosure generally relates to executing computer-readable program code instructions for selecting and applying on-screen display settings on a standalone digital display device. The present disclosure more specifically relates systems and methods for automatically applying user-selected on-screen display settings on a standalone digital display device for use among plural users based on detected user facial patterns by a visual sensor.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used to execute instructions of a graphics processing unit to provide image and video data to the standalone digital display device.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system operatively coupled to a standalone digital display device including a video scaler hardware controller to automatically apply user-selected on-screen display (OSD) settings on a standalone digital display device for use among plural users based on detected user facial patterns by a visual sensor according to an embodiment of the present disclosure;

FIG. 2 is a graphic and block illustrating an information handling system operatively coupled to a built-in standalone digital display device including a video scaler hardware controller to automatically apply user-selected OSD settings at a standalone digital display device for use among plural users based on detected user facial patterns by a visual sensor according to another embodiment of the present disclosure;

FIG. 3 is a flow diagram showing a method executing computer-readable program code instructions for automatically applying user-selected OSD settings at a standalone digital display device for use among plural users according to an embodiment of the present disclosure; and

FIG. 4 is a flow diagram showing a method of executing computer-readable program code instructions for automatically applying user-selected OSD settings at a standalone digital display device for use among plural users according to another embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Information handling systems may include any number of a plurality of input and output devices that allow a user to interact with the information handling system. Among the output devices includes a standalone digital display device. These standalone digital display devices may include both wired and wireless standalone digital display devices and may be one of potentially many standalone digital display devices used by the user to receive video data output from an operatively coupled information handling system for display to the user. These standalone digital display devices may present to a user various graphical user interfaces, images, graphics, and videos commensurate with the video data output generated at and transmitted from a graphics processing unit or other hardware processing resource executing computer readable code instructions of software or firmware at a separate information handling system.

In some examples, these standalone digital display devices may include an on-screen (OSD) settings on-board the standalone digital display device that provides the user with the ability to adjust certain visual settings of the standalone digital display device. These OSD settings may include, for example, image brightness levels, image contrast levels, audio levels (where built-in speakers are present), image color settings, frame rates, and the selection of predefined modes and configurations such as a high dynamic range (HDR) mode, a gaming mode, a preferred input source, a screen theme, etc. that are specific to the standalone digital display device. These OSD settings may be made accessible to a user via an OSD graphical user interface (GUI) that is presented to a user by actuation of a selection device on the standalone digital display device or other OSD settings interface mechanisms. However, as the standalone digital display device is used by a plurality of users, those selected OSD settings may not be preferred by each user. Indeed, as each user interfaces with the standalone digital display device, each user is required to operate the standalone digital display device with existing OSD settings or manually change those OSD settings every time the user interfaces with the standalone digital display device when the OSD settings are not preferable. In other cases, each user may be required to open operating system (OS) display settings at the current operatively coupled information handling system to set these OSD settings to the user's liking. This results in potential discomfort due to eye strain, for example, in the first instance or user down-time due to the user having to spend time adjusting those OSD settings.

To address these and other issues, the present specification describes a standalone digital display device capable of automatically applying a plurality of sets of user-selected OSD settings for use of the standalone digital display device by a plurality of different users. The standalone digital display device comprises a video scaler hardware controller, a scaler memory device, a timing controller (TCON), a display screen panel, and a power supply unit (PSU) to provide power to these and other components. In an embodiment, the standalone digital display device includes a visual sensor to capture images of a user's face. In an embodiment, the visual sensor is built into a housing of the standalone digital display device. In another embodiment, the visual sensor may be operatively coupled to the standalone digital display device via, for example, a universal serial bus (USB) port or another type of port. In yet other embodiments, the standalone digital display device may include on-board speakers, microphones, or other components, including the visual sensor, that may be subject to user-selected OSD settings as well.

Once these images of an area before the standalone digital display device have been captured, the video scaler hardware controller may execute computer-readable program code instructions of a facial detection module to detect a human face from facial patterns of a user's face that may be detected in front of the standalone digital display device. Detection of a human face may require less processing than identification of a particular user from captured images by the visual sensor. Identification of a human face in capture images may trigger identification of facial patterns for identification of a user according to embodiments herein based on the captured images of the user's face at the visual sensor. In an embodiment, the video scaler hardware controller may access the scaler storage device to compare and determine if the detected facial patterns, including a plurality of identified facial landmarks or features of the user's face match a facial pattern stored on the scaler storage device among a plurality of stored facial patterns stored for a plurality of users of the standalone digital display device. Execution of code instructions of a facial detection algorithm of a facial detection module to identify a particular user may require more compute, and thus, when executed by a scaler hardware controller on the standalone digital display device may be reserved for when a human face is detected first. When a matching facial pattern is found in scaler memory on the standalone digital display device, the video scaler hardware controller may execute computer-readable program code of a profile bridging firmware module receive stored user-selected OSD settings associated with the identified user facial pattern in a user's facial profile to automatically adjust on-screen display (OSD) settings applied to received video data from an operatively coupled information handling system. The received video data that is modified by the user-selected OSD settings for a user's facial profile may then be transmitted to the timing controller (TCON) by the video scalar hardware controller to display image and video content at a display screen panel that is adjusted according to these custom user-selected OSD settings for the identified user. This is all conducted in a closed-loop on-board the standalone digital display device and independent from the operatively coupled information handling system and regardless of which information handling system is coupled to the standalone digital display device.

In an embodiment, the video scaler hardware controller, when no detected facial patterns of the user's face match a facial pattern stored on the scaler storage device among a plurality of stored facial patterns, stores the new detected facial pattern as a distinct facial pattern and presents an OSD graphical user interface (GUI) to receive corresponding user-selected OSD settings to be associated with the distinct, new facial pattern of a new user. Execution of computer-readable code instructions of a OSD display module by the scaler hardware controller or other processing resource may present the GUI and accept OSD setting selections and store the distinct facial pattern and corresponding user-selected OSD settings for a new user on the scaler storage device. This allows newly-detected users to have facial patterns of their face to be associated with their own set of user-selected OSD settings such that, as the visual sensor detects the presence of this new user, those user-selected OSD settings are automatically applied to the operating aspects of the standalone digital display device including displaying images or audio output based on received video data from the operatively coupled information handling system.

In an embodiment, the video scaler hardware controller may execute computer-readable program code instructions of the facial detection module to detect a user's facial patterns. This includes the facial detection module detecting facial landmarks across the user's face and distances between these landmarks from captured images from the on-board visual image device, such as a camera. In an embodiment, the video scalar hardware controller matches the detected landmarks across the user's face and distances between these landmarks with stored landmarks and distances between these landmarks associated with a stored facial pattern of a plurality of stored facial patterns for user facial profiles of a plurality of users of the standalone digital display device.

In an embodiment, the video scaler hardware controller may execute the computer-readable program code instructions of the facial detection module to detect a single face among a plurality of faces of users in front of the visual sensor and select the single face of a single user among the plurality of faces of users to identify user-selected OSD settings for automatic application to received video data congruent with the matched facial pattern of the single user's facial profile stored on the scalar storage device. In another embodiment, the video scaler hardware controller may execute the computer-readable program code instructions of the facial detection module to detect a centrally-located face or closest face among a plurality of faces of users in front of the visual sensor and select the centrally-located face to select the centrally-located face of a single user among the plurality of faces of users to identify the user-selected OSD settings for automatic application to received video data congruent with the matched facial pattern of the centrally-located or closest user's facial profile stored on the scalar storage device. In either of these example embodiments, the facial detection module may separate one out of a plurality of user faces within a crowd from the image in front of the standalone digital display device in order to select from among a plurality of OSD settings to automatically adjust the viewing experience of the standalone digital display device to the user-selected OSD settings of an identified user.

In an embodiment, the visual sensor may detect an absence of a user in front of the standalone digital display device and, when detected, monitor for and detect the presence of a human face indicating return of the same or a new user. The visual sensor may then recapture images of the user to determine the facial patterns of that user to identify the previous user returning or new user seeking to use the standalone digital display device. This may be done, in an embodiment, after the visual sensor has detected the absence of the user for a period of time above an absence threshold time period. This may be done so that the scalar hardware controller executes the processes and methods described herein to identify a user and their facial profile from an identified facial pattern analysis and comparison pursuant to execution of a facial recognition algorithm only when it has been determined that the user has stepped away from the standalone digital display device and, potentially, a new user later tries to use the standalone digital display device. Operation of the standalone digital display device pursuant to the identified user-selected OSD settings may otherwise continue as long as the human face is continued as detected without interruption or an absence threshold time period has not expired. This latter human presence detection may take less processing.

The present systems and methods allow for automated adjustments of OSD settings based on detected facial patterns of a user by a visual sensor. This closed-loop user recognition and auto-application of the OSD settings allows for a plurality of users to operate the standalone digital display device, one after another, such that the individually applicable OSD settings may be automatically applied so that each user is not required to adjust settings to their individualized adjustments. Additionally, because the facial patterns of each user is stored on the scaler memory device of the standalone digital display device, they remain inaccessible to other devices and operate independently to the operatively coupled information handling system thereby securing the sensitive facial recognition data.

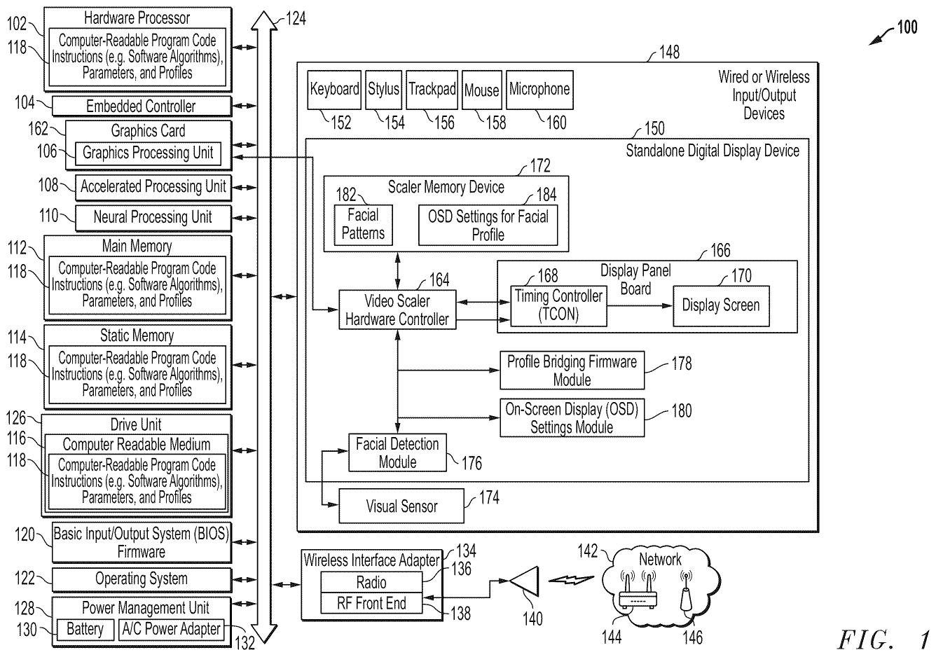

Turning now to the figures, FIG. 1 illustrates an information handling system 100 similar to the information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 144, a base station transceiver 146, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system within a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 112, (volatile (e.g., random-access memory, etc.), or static memory 114, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, a neural processing unit (NPU) 110, an accelerated processing unit (APU) 108, other types of hardware processing devices, or any combination thereof. It is appreciated that the information handling system 100 may include any number of hardware processing devices described herein. Computer readable code instructions stored in main memory 112 (e.g., RAM) may be accessible by hardware processing resources using that main memory 112. Computer-readable program code instructions stored in static memory 114, main memory 112, or drive unit 126 may be involved in invoking such computer-readable program code instructions to main memory 112 according to embodiments herein. Additional components of the information handling system 100 may include one or more storage devices such as static memory 114 or drive unit 126. The information handling system 100 may include or interface with one or more communications ports for communicating with external devices, as well as various wired or wireless input and output (I/O) devices 148, such as a mouse 158, a trackpad 156, a stylus 154, a keyboard 152, a standalone digital display device 150, a microphone 160, or any combination thereof. Portions of an information handling system 100 may themselves be considered information handling systems 100.

Information handling system 100 may include devices or modules that embody one or more of the devices or execute instructions for one or more systems and modules. The information handling system 100 may execute computer-readable program code instructions (e.g., software algorithms) parameters, and profiles 118 that may operate on servers or systems, remote data centers, or on-box in individual client information handling systems according to various embodiments herein. In some embodiments, it is understood any or all portions of computer-readable program code instructions (e.g., software algorithms) parameters, and profiles 118 may operate on a plurality of information handling systems 100.

The information handling system 100 may include the hardware processor 102 such as a central processing unit (CPU) or other hardware processing resource (e.g., 104, 106, 108, 110). Any of the hardware processing resources may operate to execute computer readable code instructions that are either firmware or software code, such as those software systems and modules described herein. Moreover, the information handling system 100 may include memory such as main memory 112, static memory 114, and disk drive unit 126 (volatile (e.g., random-access memory, etc.), nonvolatile memory (read-only memory, flash memory etc.) or any combination thereof or other memory with computer readable medium 116 storing computer-readable program code instructions (e.g., software algorithms) parameters, and profiles 118 executable by the hardware processor 102 (e.g., central processing unit), NPU 110, APU 108, EC 104, GPU 106, or any other hardware processing device. The information handling system 100 may also include one or more buses 124 operable to transmit communications between the various hardware components such as any combination of various wired or wireless I/O devices 148 as well as between hardware processors 102, an EC 104, the operating system (OS) 122, the basic input/output system (BIOS) 120, the wireless interface adapter 134, or a radio module, among other components described herein. In an embodiment, the hardware processor 102, EC 104, GPU 106, NPU 110, APU 108, and/or others may execute one or more bus drivers in order to transmit this data between the information handling system 100 and the wired or wireless input/output devices 148 described herein. In an embodiment, the information handling system 100 may be in wired or wireless communication with the wired or wireless I/O devices 148 such as a keyboard 152, a mouse 158, standalone digital display device 150, stylus 154, trackpad 156, microphone 160, among other peripheral devices. In an embodiment, for example, information handling system 100 may execute machine readable code instructions of software applications or firmware to generate video data, such as via a GPU, for images to be presented on the standalone digital display device 150. The video data may be transmitted to the standalone digital display device 150 via wired or wireless communication and modified with OSD settings automatically applied on-board at the standalone digital display device 150 before presentation of the images according to embodiments herein.

As described herein, the embodiments of the present disclosure involve the standalone digital display device 150. The standalone digital display device 150 in an embodiment may function as a liquid crystal display (LCD), an organic light emitting diode (OLED), a flat panel display, or a solid-state display. It is appreciated that the standalone digital display device 150 may be wired or wireless to allow a user to increase the desktop area by extending the desktop in an embodiment. In some embodiments, the information handling system 100 may include a digital display device that is integrated such as with a laptop information handling system, but embodiments of the present disclosure involve the standalone digital display device 150. Additionally, as described herein, the information handling system 100 may include or be operatively coupled to a cursor control device (e.g., a trackpad 156, or gesture or touch screen input), a stylus 154, and/or a keyboard 152, among others that allows the user to interface with the information handling system 100 via the standalone digital display device 150. Information handling system 100 may also be operatively coupled to a wired or wireless input/output device 148 or other hardware devices that may include a hardware processing device such as a hardware processor, microcontroller, or other hardware processing resource. Various drivers and hardware control device electronics may be operatively coupled to operate the wired or wireless I/O devices 148 according to the embodiments described herein. The present specification contemplates that the wired or wireless I/O devices 148 may be wired or wireless.

A network interface device of the information handling system 100 may be wired or wireless such as shown with wireless interface adapter 134 that can provide wireless connectivity among devices such as with Bluetooth® or to a network 142, e.g., a wide area network (WAN), a local area network (LAN), wireless local area network (WLAN), a wireless personal area network (WPAN), a wireless wide area network (WWAN), or other network. In embodiments described herein, the wireless interface device 134 with its radio 136, RF front end 138 and antenna 140 is used to communicate with the wireless peripheral devices, via, for example, a Bluetooth® or Bluetooth® Low Energy (BLE) protocols or any proprietary RF protocol such as those may utilize similar frequency ranges but proprietary modulation and data transmission characteristics. In embodiments, Bluetooth ®, BLE, proprietary RF protocol, or other WPAN or WLAN protocols and plural such protocols may be used for communication with and among any wireless peripheral device to be paired or paired with the information handling system 100 or other information handling systems.

In other embodiments, a WAN, WWAN, LAN, and WLAN may each include an AP 144 or base station 146 used to operatively couple the information handling system 100 to a network 142 via a wireless interface adapter 134. In a specific embodiment, the network 142 may include macro-cellular connections via one or more base stations 146 or a wireless AP 144 (e.g., Wi-Fi), or such as through licensed or unlicensed WWAN small cell base stations 146. Connectivity may be via wired or wireless connection. For example, wireless network wireless APs 144 or base stations 146 may be operatively connected to the information handling system 100. Wireless interface adapter 134 may include one or more RF (RF) subsystems (e.g., radio 136) with transmitter/receiver circuitry, modem circuitry, one or more antenna RF (RF) front end 138 circuits, one or more wireless controller circuits, amplifiers, antennas 140 and other circuitry of the radio 136 such as one or more antenna ports used for wireless communications via multiple radio access technologies (RATs). The radio 136 may communicate with one or more wireless technology protocols.

In an embodiment, the wireless interface adapter 134 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP 2, Bluetooth® standards, proprietary RF protocol, or similar wireless standards may be used. Wireless interface adapter 134 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 134 can represent an add-in card, wireless network interface module that is integrated with a main board of the information handling system 100 or integrated with another wireless network interface capability, or any combination thereof.

In some embodiments, a hardware processing resource executes computer-readable program code instructions of software or firmware on-board the standalone digital display device 150, such as via a scaler hardware controller 164, to implement one or more of some systems and methods described herein, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware devices with related control and data signals that may be communicated between and through the modules, or as portions of an application-specific integrated circuit (ASIC). Accordingly, the present system encompasses a hardware processing resource executing computer-readable program code instructions of software or firmware as well as hardware implementations or any combination.

In accordance with various embodiments of the present disclosure, the methods described herein may be implemented by firmware or software programs executable by a hardware controller 164 or a hardware processor system on-board the standalone digital display device 150. Further, in an exemplary, non-limited embodiment, the information handling system may execute software or firmware via hardware processing resources 102, 104, 106, 108, or 110 to generate video data for transmission to the standalone digital display device 150 and may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes computer-readable program code instructions, parameters, and profiles 118 or receives and executes computer-readable program code instructions, parameters, and profiles 118 responsive to a propagated signal, so that a hardware device connected to a network 142 may communicate voice, video, or data over the network 142. Further, the computer-readable program code instructions, parameters, and profiles 118 may be transmitted or received over the network 142 via the network interface device or wireless interface adapter 134.

The information handling system 100 may include a set of computer-readable program code instructions, parameters, and profiles 118 that may be executed to cause the computer system to perform any one or more of the methods or computer-based functions disclosed herein. For example, computer-readable program code instructions, parameters, and profiles 118 may be executed by a hardware processor 102, GPU 106, EC 104, APU 108, NPU 110, or any other hardware processing resource and may include software agents, or other aspects or components used to generate video data for presentation of images at the standalone digital display device 150 during execution of the methods and systems described herein. Various software modules comprising application computer-readable program code instructions, parameters, and profiles 118 may be coordinated by an operating system (OS) 122, and/or via an application programming interface (API) include a unified device API described herein. An example OS 122 may include Windows®, Android®, and other OS types. Example APIs may include Win 32, Core Java API, or Android APIs.

In an embodiment, the information handling system 100 may include a disk drive unit 126. The disk drive unit 126 and may include machine-readable program code instructions, parameters, and profiles 118 in which one or more sets of machine-readable program code instructions, parameters, and profiles 118 such as firmware or software can be embedded to be executed by the hardware processor 102 (e.g., CPU) or other hardware processing devices such as a GPU 106, an EC 104, an NPU 110, an APU 108, or other hardware processing resource device to perform the processes described herein. Similarly, main memory 112 and static memory 114 may also contain a computer-readable medium for storage of one or more sets of machine-readable program code instructions, parameters, or profiles 118 described herein. The disk drive unit 126 or static memory 114 also contain space for data storage. Further, the machine-readable program code instructions, parameters, and profiles 118 may embody one or more of the methods as described herein. In a particular embodiment, the machine-readable program code instructions, parameters, and profiles 118 may reside completely, or at least partially, within the main memory 112, the static memory 114, and/or within the disk drive 126 during execution by the hardware processor 102, EC 104, APU 108, NPU 100, or GPU 106 of information handling system 100.

Main memory 112 or other memory of the embodiments described herein may contain computer-readable medium (not shown), such as RAM in an example embodiment. An example of main memory 112 includes random access memory (RAM) such as static RAM (SRAM), dynamic RAM (DRAM), non-volatile RAM (NV-RAM), or the like, read only memory (ROM), another type of memory, or a combination thereof. Static memory 114 may contain computer-readable medium (not shown), such as NOR or NAND flash memory in some example embodiments. The applications and associated APIs, for example, may be stored in static memory 114 or on the disk drive unit 126 that may include access to a machine-readable code instructions, parameters, and profiles 118 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 128 (a.k.a. a power supply unit (PSU)). The PMU 128 may include a hardware controller and executable machine-readable code instructions to manage the power provided to the components of the information handling system 100 such as the hardware processor 102 and other hardware components described herein. The PMU 128 may control power to one or more components including the one or more drive units 126, the hardware processor 102 (e.g., CPU), the EC 104, the GPU 106, the APU 108, the NPU 110, the video/graphic display device 150, or other wired or wireless I/O devices 148 such as the mouse 158, the stylus 154, the keyboard 152, and the trackpad 156 and other components that may require power when a power button has been actuated by a user. In an embodiment, the PMU 128 may monitor power levels and be electrically coupled to the information handling system 100 in embodiments herein to provide this power. The PMU 128 may be coupled to the bus 124 to provide or receive data or machine-readable code instructions. The PMU 128 may regulate power from a power source such as the battery 130, or AC power adapter 132. In an embodiment, the battery 130 may be charged via the AC power adapter 132 and provide power to the components of the information handling system 100, via wired connections, or when AC power from the AC power adapter 132 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 116 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described herein, the information handling system 100 is operatively coupled to a standalone digital display device 150. The standalone digital display device 150 may be operatively coupled to the information handling system 100 via a wired connection such as a universal serial bus (USB) cable via a port such as a USB port formed into the information handling system 100 in some embodiments. Additionally, or alternatively, the standalone digital display device 150 may be operatively coupled to the information handling system 100 via a wireless connection using the wireless interface device 134 and appropriate wireless protocols described herein. It is appreciated that, although FIG. 1 shows the standalone digital display device 150 being operatively coupled to the information handling system 100, the present specification contemplates that the standalone digital display device 150 may operate in a stand-alone manner such that the systems and methods described herein can operate independently to automatically apply user-selected OSD settings without control from the information handling system 100.

In order to interface with the standalone digital display device 150, the information handling system 100 includes a GPU 106 formed on a graphics card 162 that transmits image, video, and GUI data as “video data” to the standalone digital display device 150. The GPU 106 may be any hardware processing device that accelerates graphics rendering tasks such as rendering images, videos, and animations for representation on the display screen 170 of the standalone digital display device 150. It is appreciated, however, that any hardware processing device such as the hardware processor 102 (e.g., CPU), the EC 104, the APU 108, or the NPU 110 may also be used in tandem with or without the GPU 106 to render the images, videos, and animations in video data for representation on the display screen 170 of the standalone digital display device 150.

The standalone digital display device 150 may include or be operatively coupled to a visual sensor 174 on-board the standalone digital display device 150. In the context of the present specification, the visual sensor 174 may be any device that can capture, at least, a portion of the user's face to identify a human face in captured images and provide output facial data that is used to recognize facial patterns and landmarks according to embodiments. In an embodiment, the visual sensor 174 may include a dedicated hardware processor or microcontroller that can detect these facial patterns such as landmarks on the user's face to identify a human face, identify the facial patterns, and provide this data for facial patterns as output to, for example, the facial detection module 176 executing at a video scaler hardware controller 164 within the standalone digital display device 150. Alternatively, the visual sensor 174 may identify a human face, which requires lower processing requirements, and provide raw image output and identification of a human face to the facial detection module 176 executing on video scaler hardware controller 164 to analyze and define facial landmarks, facial patterns, and other features of the user's face in order to detect the location of the user's face in front of the standalone digital display device 150 and prepare an identification of the user from the facial patterns for comparison to facial patterns in facial profiles stored at a scaler memory device 172 at the standalone digital display device 150. In either example, at least a portion of the user's face is captured and analyzed to identify a human face in the image captured in front of the standalone digital display device 150. Then these images with facial patterns of the user's face are processed to define facial landmarks and facial features on the user's face in a facial pattern to be associated with a user. In an embodiment, the visual sensor 174 may be any type of camera. In an embodiment, the visual sensor 174 may be a time-of-flight (ToF) camera to detect distances to objects such as a user's face. In an embodiment, the visual sensor 174 may be an imaging device that can capture either or both a two-dimensional image or a three-dimensional image of the user's face. In an embodiment, the visual sensor 174 may be an RGB camera that captures color images of the user's face, an infrared (IR) camera that captures depth and thermal information from the user's face, a ToF camera that measures the three-dimensional shape of the user's face, a light detection and ranging (LIDAR) that measures the three-dimensional shape of the user's face, and/or an ultrasonic sensor that measures the three-dimensional shape of the user's face. In an embodiment, the visual sensor 174 may implement one or a plurality of these technologies in order to capture one or more images of the user's face as the user moves within the frame of the visual sensor 174 in front of the standalone digital display device 150.

As the visual sensor 174, in real-time, captures the images of the user's face, the output from the visual sensor 174 is provided to a facial detection module 176. Again, the facial detection module 176 may be, in part, integral to the visual sensor 174 with a microcontroller or other hardware processor of the visual sensor 174 executing the computer-readable program code instructions of the facial detection module 176 to detect a human face and then determine facial patterns of a user's face based on those captured images of the user's face at the visual sensor 174. Again, in other embodiments, the facial detection module 176 may be executed by the video scaler hardware controller 164 formed on, for example, a scaler board (not shown) within the standalone digital display device 150 and receive images captured by the visual sensor 174 in a closed-loop on the standalone digital display device 150 for determination of the facial patterns of a user's face for identification of a user and comparison to other stored facial patterns of facial profiles of other users of the standalone digital display device 150.

As described herein, execution of the computer-readable program code instructions of the facial detection module 176 may, in an embodiment, include facial recognition algorithms to detect a plurality facial landmarks of the user's face, relationships between some of a plurality of the facial landmarks, and other facial features within the facial patterns for identification of a user. These facial landmarks may include, for example, any points or features of the user's face such as position and shape of the user's eyes, distance between the user's eyes, specific points of the user's eyes such as the corner of the eyes, eyebrow shape, location, outer and inner corners of the user's eyebrows, relative angle to the user's eyes, location of the user's nose features such as the tip, bridge and nostrils, location of the user's mouth features such as the corners, center of lips, and upper and lower lip boundaries, locations and features of the user's chin, jawline, and cheekbones, location of the user's forehead, location of the user's ears, and the location of any plurality of these facial landmark features relative to each other.

In an example embodiment, the facial recognition algorithm is executed to use these landmarks as anchor points for mapping the geometry and proportions of a face within a captured image. In an embodiment, the scaler hardware controller 164 may execute any type of facial recognition algorithm on-board the standalone digital display device 150 to identify landmarks on a user's face and develop a facial pattern for that user. These facial recognition algorithms may include any convolutional neural network such as MobileNet® developed by Google®, FaceNet® developed by Google®, a visual descriptor such as local binary patterns histograms (LBPH) or Open Source Computer Vision (OpenCV) by Intel®, and Eigenface among other algorithms. MobileNet® may be designed for process resource-constrained devices (e.g., those including lower power devices) such as the standalone digital display device 150 and may have a relatively high accuracy of 99%. Eigenface may be suitable for basic facial recognition tasks that are easy to implement with OpenCV and may have a moderate level of accuracy with sensitivities to lighting and facial expressions. Eigenface also requires a relatively low computational resources and could be executed by the hardware microcontroller or other hardware processing resource of the visual sensor 174 or by the video scaler hardware controller 164 of the standalone digital display device 150. FaceNet may be relatively accurate but may require relatively higher computational resources such as those associated with the video scaler hardware controller 164 or an additional hardware processing resource of the standalone digital display device 150. In an embodiment, therefore, such as where FaceNet is used, video scaler hardware controller 164 of the standalone digital display device 150 may operate along with another hardware processing resource on-board the standalone digital display device 150 to execute this facial recognition algorithm in order to develop a facial pattern of a user. LBPH may also be highly accurate with low computation resource consumption and may be executed by the video scaler hardware controller 164 on the standalone digital display device 150 in other embodiments. It is contemplated that any suitable facial recognition algorithm may be executed as part of the facial detection module 176 by any combination of the hardware processing resource of the visual sensor 174, video scaler hardware controller 164 or other hardware processing resources on-board the standalone digital display device 150 in embodiments herein.

In a particular embodiment, the hardware processing resource of the visual sensor 174 may execute a portion of the facial detection module 176 to capture images and identify a human face in those images. Then, the video scaler hardware controller 164 or other hardware processing resources on-board the standalone digital display device 150 may execute the portion of the facial detection module 176 to determine the facial patterns and particular plurality of facial landmarks for identification of a user and comparison to stored facial patterns of a plurality of facial profiles for a plurality of users of the standalone digital display device 150 in embodiments herein. It is appreciated that any number of facial recognition algorithms may be used, and the present specification contemplates the use of these other types of algorithms. In an embodiment, each of the facial features detected by execution of any facial recognition algorithm may be used, in an embodiment, to identify a specific user and may be saved in a scaler memory device 172 for later use and identification of a specific user during operation of the systems and methods described herein.

As the facial detection module 176 detects these landmarks and develops a facial pattern of the user presently in front of the standalone digital display device 150 and imaged by the visual sensor 174, this facial patterns may be compared to other facial patterns saved on the scaler memory device 172. Where no facial patterns have been saved on the scaler memory device 172 such as when the standalone digital display device 150 has been newly purchased, the video scaler hardware controller 164 may cause the developed facial pattern to be saved on the scaler memory device 172. At this point, the video scaler hardware controller 164 may also execute computer readable code instructions of an on-screen display (OSD) settings module to present, to the user, a graphical user interface (GUI) depicting on-screen display (OSD) settings.

In an embodiment, the video scaler hardware controller 164 may execute computer-readable program code instructions of an on-screen display settings module 180 to present to the user an OSD settings GUI that depicts the options available for the OSD settings available to the user. These OSD settings may include, for example, image brightness levels, image contrast levels, audio levels (where built-in speakers are present), image color settings, frame rates, and the selection of predefined modes and configurations such as a high dynamic range (HDR) mode, a gaming mode, a preferred input source, a screen theme, and the like. The OSD settings GUI presenting the OSD settings may require that the user provide inputs as to how to, if at all, adjust the OSD settings and/or accept the OSD settings as they are currently constituted and stores the user-selected OSD settings in a facial profile for the user on the scaler memory device 172.

When the video scaler hardware controller 164 has received the selection of user-selected OSD settings from the user, these user-selected OSD settings may be saved on the scaler memory device 172 and associated with the user's facial pattern in the facial profile for that user of the standalone digital display device 150. These custom, user selected OSD settings and facial pattern for the user in a facial profile may be later used by the system described herein to automatically apply those user-selected OSD settings to received video data when the user's presence is detected in captured images of the user's face before the standalone digital display device 150. Again, the facial detection module 176 detects the facial patterns of the user's face in captured images and compares those detected facial patterns with those stored in the facial profile of the user on the scaler memory device 172.

Where, for example, the scaler memory device 172 does contain one or more sets of facial patterns (e.g., data defining facial patterns of a user) and associated user-selected OSD settings (e.g., data describing those user-selected and preferred OSD settings), the execution of the computer-readable program code instructions of the facial detection module 176 by the video scaler hardware controller 164 may compare the currently detected facial pattern of a user's face detected by the visual sensor 174 and defined by the facial detection module 176 with a facial pattern with a plurality of facial landmarks to those stored facial patterns of users facial profiles stored on the scaler memory device 172. Where a matching facial pattern is found on the scaler memory device 172, those associated user-selected OSD settings from the facial profile of that identified user and associated with the matching facial pattern are automatically applied via execution of the computer-readable program code instructions of the on-screen display settings module 180 and the profile bridging firmware module 178 by the video scaler hardware controller 164. In an embodiment, the video scaler hardware controller 164 may execute computer-readable program code instructions of a profile bridging firmware module 178 to read the user-selected OSD settings associated with the matching facial patterns of an identified user facial profile and interface with the on-screen display settings module 180 to automatically apply those user-selected OSD settings to any incoming video data from an operatively coupled information handling system 100. This operates independently on the standalone digital display device 150 from the operatively coupled information handling system 100 in embodiments herein. Application of these user-selected OSD settings may affect how the video scaler hardware controller 164 processes the video data received from the information handling system 100 and determines how the TCON 168 is to process and present this video data at the display panel 166 for presentation of images on the display screen 170. Where no match facial pattern is found on the scaler memory device 172, however, the video scaler hardware controller 164 may determine that this new facial pattern detected by the visual sensor 174 and facial detection module 176 may also be stored as a new facial pattern to be saved on the scaler memory device 172. Again, the video scaler hardware controller 164 may execute computer-readable program code instructions of the on-screen display settings module 180 to present an OSD settings GUI to the user to request input related to what the user-selected OSD settings are to be set at.

It is appreciated that the scaler memory device 172 may store any number of a plurality of sets of facial patterns and user-selected OSD settings in user facial profiles associated with a commensurate number of users. However, in an embodiment, the storage capacity of the scaler memory device 172 may be minimal or security issues may require limits. In such an embodiment, new sets of facial patterns and user-selected OSD settings may not be saved without some form of explicit authorization being received at the OSD settings GUI. In another embodiment, the scaler memory device 172 may store a limited number of sets of facial patterns and user-selected OSD settings in user facial profiles associated with a set number of users (e.g., 5 users). In this embodiment, any newly detected facial pattern by the facial detection module 176 may be stored with a date and timestamp data in a facial profile and may cause one of the currently-stored facial patterns and user facial profiles to be deleted and replaced with the newly-detected facial pattern and facial profile in a first-in, first-out manner or based on oldest age from associated date and timestamp data for each facial profile. In an embodiment, the video scaler hardware controller 164 may also monitor the lifetime of each of the sets of facial patterns and user-selected OSD settings in user facial profiles and automatically delete one or more sets of facial patterns and user-selected OSD settings of user facial profiles if date and timestamp data exceeds an expiry date threshold of time without use. This date and timestamp data for the user facial profiles may be reset upon detection of a user's face and each time automatic use is made of the user-selected OSD settings for that user in embodiments herein.

The present systems and methods allow for automated adjustments to user-selected OSD settings based on detected facial patterns of a user by the visual sensor 174 and facial detection module 176 executing on-board a standalone digital display device 150. This closed-loop user recognition and auto-application of the custom, user-selected OSD settings allows for a plurality of users to operate the standalone digital display device 150, one after another, such that the individually applicable, user-selected OSD settings may be automatically applied to incoming video data so that each user is not required to adjust settings to their individualized adjustments on the standalone digital display device 150. Further, these user-selected OSD settings may be applied for a detected user's face regardless of which information handling system 100 is operatively coupled to the standalone digital display device 150. Additionally, because the facial patterns of each user is stored in user facial profiles on the scaler memory device 172 and the systems and methods of the present disclosure operate on-board the standalone digital display device 150 independently of any information handling system 100 coupled thereto, they remain inaccessible to other devices thereby securing the sensitive facial recognition data in embodiments herein.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

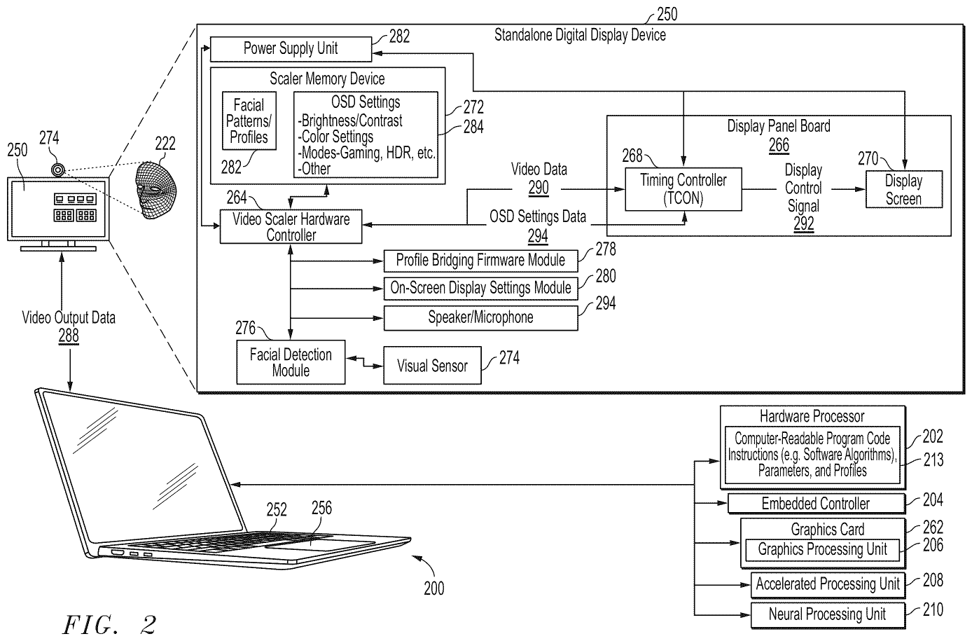

FIG. 2 is a graphic and block illustrating an information handling system 200 operatively coupled to a standalone digital display device 250 including a video scaler hardware controller 264 to automatically apply user-selected OSD settings on the standalone digital display device 250 based on detected user facial patterns of a user's face by a visual sensor 274 according to embodiments of the present disclosure. The information handling system 200 in FIG. 2 is shown as a laptop-type information handling system 200 according to some embodiments of the present specification.

The information handling system 200 may be operatively coupled to a standalone digital display device 250 to provide image output to the user. The information handling system 200 may include other I/O devices as well such as a keyboard 252, a touchpad 256, and other input devices for the user to provide input to the information handling system 200, and may include an integrated display such as for a laptop information handling system 200. The information handling system 200 may be operationally coupled to one or more external input/output devices (e.g., 148, FIG. 1) such as the external standalone digital display device 250. The present specification contemplates that the standalone digital display device 250 may be a wired or wireless external standalone digital display device 250. It is appreciated that other types of information handling systems may be used and the information handling system 200 presented in FIG. 2 is presented as an example of an information handling system 200 that can be used with the systems and methods described herein.

FIG. 2 also shows that the visual sensor 274 forms part of the standalone digital display device 250 and, in an embodiment, may be an internal part of the standalone digital display device 250 by being formed into the housing of the standalone digital display device 250. In another embodiment, the visual sensor 274 may be a separate input device that is operatively coupled to the standalone digital display device 250 via, for example, a universal serial bus (USB) port formed on the standalone digital display device 250. In this embodiment, the visual sensor 274 may be a webcam or other similar video or image capturing device and may operate closed-loop with the video scaler hardware controller 264 for execution of embodiments herein.

As described herein, the information handling system 200 may be operatively coupled to an external standalone digital display device 250 via a wired connection such as a universal serial bus (USB) cable via a port such as a USB port formed into the information handling system 200. The example embodiment presented in FIG. 2 shows a built-in standalone digital display device 250 operatively coupled to the laptop-type information handling system 200 which may be a laptop information handling system having its own separate display device. However, because the information handling system 200 may include desktop expansion capabilities, one or more standalone digital display devices 250 may be operatively coupled to the information handling system 200 as external standalone digital display devices 250 and these may operate pursuant to the systems and methods described herein independently of the information handling system 200.

In order to interface with the standalone digital display device 250 (or a plurality of standalone digital display devices 250), the information handling system 200 includes a GPU 206 formed on a graphics card 262 that generates and transmits image, video, and GUI data as video data to the standalone digital display device 250. The GPU 206 may be any hardware processing device that accelerates graphics rendering tasks such as rendering images, videos, and animations pursuant to execution of software application or firmware at the information handling system 200 for representation on the display screen panel 270 of the standalone digital display device 250. It is appreciated, however, that any hardware processing device such as the hardware processor 202 (e.g., CPU), the EC 204, the APU 208, or the NPU 210 may also be used in tandem with or without the GPU 206 to render the images, videos, and animations of the video data for representation on the display screen panel 270 of the standalone digital display device 250.

The standalone digital display device 250 may include or be operatively coupled to a visual sensor 274. In the context of the present specification, the visual sensor 274 may be any device that can capture, at least, a portion of the user's face and identify presence of a human face to provide output facial data that is used to recognize facial patterns and landmarks. In an embodiment, the visual sensor 274 may include a dedicated hardware processor or microcontroller that can detect facial patterns such as facial landmarks on the user's face from captured images as well as other facial features patterns of a human face and provide this data as output to, for example, the facial detection module 276. Some or all of the facial detection module 276 may execute on the hardware processing resource of the visual sensor 274 or on a video scaler hardware controller 264 within the standalone digital display device 250 in various embodiments herein. For example, the visual sensor 274 may execute a portion of the facial detection module 276 to capture images and detect a human face to provide captured image output and a detected human face to the facial detection module 276 portion executing at a video scaler hardware controller 264. Execution of the facial detection module at the video scaler hardware controller 264 on the standalone digital display device 250 may then analyze and define a plurality of facial landmarks, relationships between any of those facial landmarks in the facial patterns of the user's face, and other features of the user's face in order to detect the location and identify of a user's face in front of the standalone digital display device 250 as compared to other faces of other user's.

In an example embodiment, at least a portion of the user's face is captured and analyzed to identify some facial patterns of the user's face for identification of a human face by the visual sensor 274 and its hardware resource. Further, the hardware resource of the visual sensor may execute to define a plurality of facial landmarks on the human face detected that is the user's face in the captured images. In an embodiment, the visual sensor 274 may be any type camera, including ToF visual sensors to detect distance of objects such as human faces in captured images. In an embodiment, the visual sensor 274 may be an imaging device that can capture either or both a two-dimensional image or a three-dimensional image of the user's face. In an embodiment, the visual sensor 274 may be an RGB camera that captures color images of the user's face, an IR camera that captures depth and thermal information from the user's face, a ToF camera that measures the three-dimensional shape of the user's face, a stereo vision camera that captures a 3D image, a multispectral camera that captures images of the user's face over a variety of lighting conditions, a LIDAR that measures the three-dimensional shape of the user's face, and/or an ultrasonic sensor that measures the three-dimensional shape of the user's face. In an embodiment, the visual sensor 274 may implement one or a plurality of these technologies in order to capture one or more images of the user's face as the user moves within the frame of the visual sensor 274.

As the visual sensor 274, in real-time, captures the images of the user's face and may execute a portion of the facial detection module 276 to identify a human face in the image, the output from the visual sensor 274 is provided to another portion of the facial detection module 276 executing on-board the standalone digital display device 250 in a closed-loop. Again, any portion of the facial detection module 276 may be integral to the visual sensor 274 with a microcontroller or other hardware processor of the visual sensor 274 as well as a portion executing the computer-readable program code instructions of the facial detection module 276 on the video scaler hardware controller 264 to detect facial patterns of a user's face for identifying a user and comparing those user facial patterns with stored facial patterns based on those captured images of the user's face at the visual sensor 274. Again, in various alternative embodiments, any portions of the facial detection module 276 may be executed by the video scaler hardware controller 264 formed on, for example, a scaler board (not shown) within the standalone digital display device 250 and the closed-loop visual sensor 274 hardware processing resource.

Again, execution of the computer-readable program code instructions of the facial detection module 276 with any of a plurality of facial recognition algorithms may, in an embodiment, detect plural facial landmarks of the user's face, relative location of any plurality of facial landmarks, or other facial features of a user's face within capture images to determine the facial patterns for a user's identity. These facial landmarks may include, for example, any points or features of the user's face such as position and shape of the user's eyes, distance between the user's eyes, specific points of the user's eyes such as the corner of the eyes, eyebrow shape, location, outer and inner corners of the user's eyebrows, relative angle to the user's eyes, location of the user's nose features such as the tip, bridge and nostrils, location of the user's mouth features such as the corners, center of lips, and upper and lower lip boundaries, locations and features of the user's chin, jawline, and cheekbones, location of the user's forehead, location of the user's ears, and the location of any plurality of these facial landmark features relative to each other. In an example embodiment, the facial recognition algorithm of the facial detection module 276 uses these landmarks as anchor points for mapping the geometry and proportions of a face to uniquely identify a user. In an embodiment, the scaler hardware controller 264 may execute any type of facial recognition algorithm to identify landmarks on a user's face and develop a facial pattern for that user. These facial recognition algorithm may include any convolutional neural network such as MobileNet® developed by Google®, FaceNet® developed by Google®, a visual descriptor such as local binary patterns histograms (LBPH) or Open Source Computer Vision (OpenCV) by Intel®, and Eigenface among other algorithms. MobileNet® may be designed for process resource-constrained devices (e.g., those including lower power devices) such as the standalone digital display device 250 and may have a relatively high accuracy of 99%. Eigenface may be suitable for basic facial recognition tasks that are easy to implement with OpenCV and may have a moderate level of accuracy with sensitivities to lighting and facial expressions. Eigenface also requires a relatively low computational resources and could be executed by hardware resource of the visual sensor or the video scaler hardware controller 264 of the standalone digital display device 250 to identify a human face for example or to further identify a user's facial patterns. FaceNet may be relatively accurate but may require relatively higher computational resources such as those associated with the video scaler hardware controller 264 or other hardware processing resources on the standalone digital display device 250. In an embodiment, therefore, where FaceNet is used, the video scaler hardware controller 264 on the standalone digital display device 250 may receive the captured images from the visual sensor 274 to execute this facial recognition algorithm in order to develop a facial pattern for identification of a user and storage with a facial profile of the user. LBPH may also be highly accurate with low computation resource consumption and may be executed by the video scaler hardware controller 264 on the standalone digital display device 250 in embodiments herein.

It is appreciated that any number of facial recognition algorithms may be used, and the present specification contemplates the use of these other types of algorithms. In an embodiment, any plurality of the facial landmark features detected by execution of any facial recognition algorithm may be used, in an embodiment, to generate a user facial pattern to identify a specific user and may be saved in a scaler memory device 272 for later use and identification of the specific user during operation of the systems and methods described herein.

As the facial detection module 276 detects these facial landmarks and develops a facial pattern of the user presently in front of the standalone digital display device 250 and imaged by the visual sensor 274, this facial pattern for the user may be compared to other facial patterns saved on the scaler memory device 272. Where no facial patterns have been saved on the scaler memory device 272, such as when the standalone digital display device 250 has been newly purchased, the video scaler hardware controller 264 cause the developed facial pattern to be saved on the scaler memory device 272. At this point, the video scaler hardware controller 264 also may execute code instructions of an on-screen display (OSD) settings module 280 to present, to the user, an OSD settings graphical user interface (GUI) depicting options for a user to select on-screen display (OSD) settings. In an embodiment, this OSD settings GUI is presented to the user via operation of the TCON 268 and the scaler hardware controller 264 depicting the OSD settings GUI generate by the on-screen display settings module 280. The TCON 268 causes this OSD settings GUI to be displayed on the display screen 270 on the display panel board 266 by transmitting the appropriate display control signals 292 to the display screen 270. By interacting with the keyboard 252, the trackpad 256, or any other input device described herein, the user may make user-specific selections, via input received at the operatively coupled information handling system 200 and forwarded to the standalone digital display device 250 to adjust settings thereby defining the user-selected OSD settings to be used with the user's stored facial profile. In other embodiments, an on-board input device such as buttons or a touchscreen on the standalone digital display device 250 may be used to receive input of selection of the user-selected OSD settings at the OSD settings GUI.

In an embodiment, the video scaler hardware controller 264 may execute computer-readable program code instructions of an on-screen display settings module 280 to present to the user this OSD settings GUI depicting the options available for the OSD settings. These OSD settings may include, for example, image brightness levels, image contrast levels, audio levels (where built-in speakers are present), image color settings, frame rates, and the selection of predefined modes and configurations such as a high dynamic range (HDR) mode, a gaming mode, a preferred input source, a screen theme, and the like. The OSD settings GUI presenting the OSD settings may require that the user provide inputs as to how to, if at all, adjust the OSD settings and/or accept the OSD settings as they are currently constituted for a set of user-selected OSD settings for a user.

When the video scaler hardware controller 264 has received the user's selection of OSD settings, these user-selected OSD settings may be saved on the scaler memory device 272 and associated with the user's facial pattern in a user facial profile. This user-selected OSD settings set and facial pattern of the user's facial profile may be later used by the system described herein to automatically apply those user-selected OSD settings to video data 290 received from the operatively coupled information handling system 200 when the user's presence is detected. For example, when the facial detection module 276 has detected the facial patterns of the user and compared those detected facial patterns with those stored on the scaler memory device 272, the user-selected OSD settings 294 is transmitted as the OSD settings data 294 to the TCON 268 to be applied to the video data 290 in embodiments herein.

Where, for example, the scaler memory device 272 does contain one or more sets of facial patterns (e.g., data defining facial patterns of a user) with associated user-selected OSD settings (e.g., data describing those user-selected and preferred OSD preferences) in stored user facial profiles, the execution of the computer-readable program code instructions of the facial detection module 276 by the video scaler hardware controller 264 may compare the currently available facial pattern detected by the visual sensor 274 and defined by the facial detection module 276 with those facial patterns and OSD settings sets stored on the scaler memory device 272. Where a matching facial pattern is found on the scaler memory device 272, those user-selected OSD settings associated with matching facial pattern are automatically applied to video data 290 in OSD settings data 294 sent to the TCON 268 at the display panel board 266. In an embodiment, execution of the computer-readable program code instructions of the profile bridging firmware module 278 and the on-screen display settings module 280 by the video scaler hardware controller 264 causes those user-selected OSD settings to be applied with the OSD settings module 280 sending the OSD settings data 294 to the TCON 268. In an embodiment, the video scaler hardware controller 264 may execute computer-readable program code instructions of a profile bridging firmware module 278 to read the user-selected OSD settings associated with the matching facial patterns from the identified user's facial profile stored on the scaler memory device 272 and interface with the on-screen display settings module 280 to automatically apply those user-selected OSD settings in OSD settings data 294. Application of these user-selected OSD settings may affect how the TCON 268 processes video data 290 input from the operatively coupled information handling system 200 to determine how the TCON 268 presents this video data 290 as images at display screen 270 of the display panel board 266 in embodiments herein.

Where no match facial pattern is found on the scaler memory device 272, however, the video scaler hardware controller 264 may determine that the facial pattern detected by the visual sensor 274 and facial detection module 276 may also be stored as a new facial pattern to be saved on the scaler memory device 272. Again, the video scaler hardware controller 264 may execute computer-readable program code instructions of the on-screen display settings module 280 to present the OSD settings GUI to the user to request input related to what the user-selected OSD settings are to be for that user.

It is appreciated that the scaler memory device 272 may store any number of a plurality of sets of facial patterns and user-selected OSD settings sets in user facial profiles associated with a commensurate number of users. For example, one set of facial patterns and user-selected OSD settings in a facial profile may be associated with a father within a home that has adjusted the brightness settings of the user-selected OSD settings to lower the brightness of the display screen 270 in his user-selected OSD settings. Still further, another user, such as a mother in a home, may wish to have the audio settings of one or more speakers or microphone 294 of the standalone digital display device 250 set to a lower the volume in her user-selected OSD settings. Even further, another user, such as a child within the home, may adjust visual settings associated with the standalone digital display device 250 to a high dynamic range (HDR) mode setting to make the images presented on the display screen 270 more vivid in the user-selected OSD settings. Each of these user-selected OSD settings are specific to the individual user and are set up by the user when the visual sensor 274 and facial detection module 276 determines that the facial pattern detected is one not present in the scaler memory device 272. These custom user-selected OSD settings for the standalone digital display device 250 may be automatically applied to the received video data from any operatively coupled information handling system 200 to the shared standalone digital display device 250 in embodiments herein. Thus, the standalone digital display device 250 may be used by multiple users in a home or office and may interface with any of a plurality of operatively coupled information handling systems 200 while providing custom, user-selected OSD settings for a user detected by the visual sensor 274 of the standalone digital display device 250.

It is appreciated that the process of detecting a new user, generating a new set of facial patterns, and receiving the OSD settings from the user may be repeated for any number of users. However, in an embodiment, the storage capacity of the scaler memory device 272 may be limited or for security reasons new sets of facial patterns and OSD settings may not be saved. In an embodiment, the scaler memory device 272 may store a limited number of sets of user facial patterns and user-selected OSD settings in a limited number of facial profiles associated with a set number of users (e.g., 5 or 10 users). In this embodiment, any newly detected facial pattern by the facial detection module 276 may cause one of the currently-stored facial patterns to be deleted and replaced with the newly-detected facial pattern. In some embodiments, this may be done in a first-in, first-out manner. In other embodiments, each facial profile may include a date and time stamp stored on the scaler memory device 272. In such an embodiment, the oldest of the currently-stored user facial profiles may be deleted for a newly-detected facial pattern and a new user facial profile in some embodiments. This date and time stamp data for each user profile may be reset anytime a user facial profile and user-selected OSD settings are automatically invoked by detection of that user. Thus, the deleted facial profile from the scaler memory device 272 may be one that has an oldest date and time stamp when a new user facial profile is to be saved. In another embodiment, the video scaler hardware controller 264 may monitor the lifetime of each of the sets of facial patterns and user-selected OSD settings of user facial profiles and automatically delete one or more sets of facial patterns and OSD settings if they exceed an expiry date in the date and time stamp data since a last use.

FIG. 2 further shows a power supply unit (PSU) 282 within the standalone digital display device 250. As described herein, the standalone digital display device 250 may be powered via a PMU within the information handling system 200 via a power/data cable operatively coupling the information handling system 200 to the standalone digital display device 250. Alternatively, the standalone digital display device 250 may be powered using a power cable operatively coupling an A/C power source to the PSU 274 within the standalone digital display device 250. The PSU 282 may operate similarly to the PMU described in connection with the information handling system 200 by regulating power from the A/C power source to each of the components of the standalone digital display device 250 such as the video scaler hardware controller 264, the TCON 268, scaler memory device 272, and the display screen 270, the visual sensor 274, as well as other components of the standalone digital display device 250 described herein.

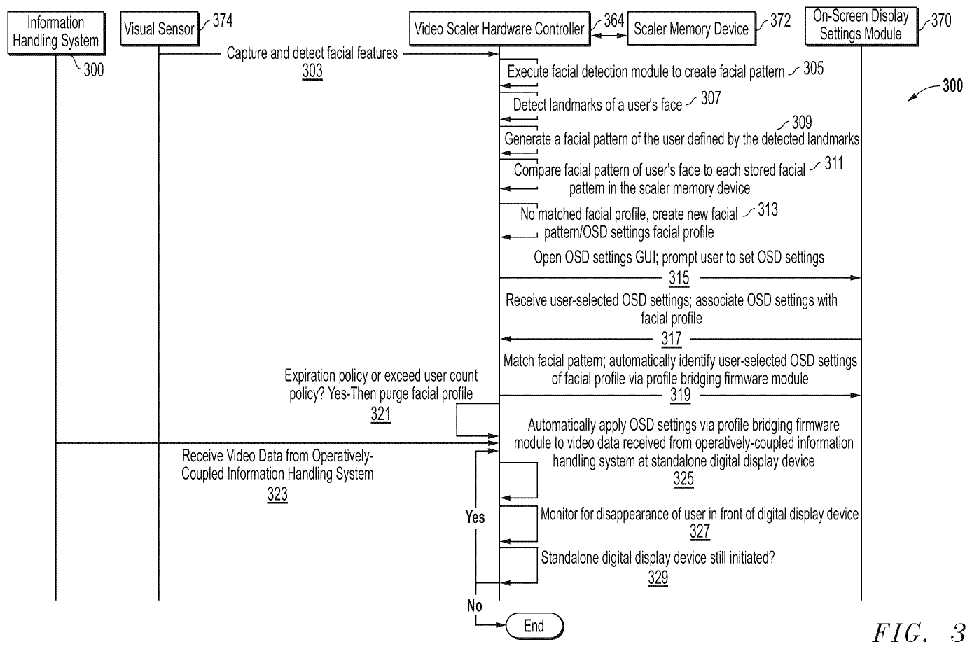

FIG. 3 is a flow diagram showing a method of executing computer-readable program code instructions for automatically setting OSD settings onboard a standalone digital display device independently from an operatively coupled information handling system providing video data according to an embodiment of the present disclosure. This method may be implemented on one or more of the standalone digital display devices such as those described in connection with FIGS. 1 and 2.

The method may include, at line 303, with the visual sensor 374 capturing and detecting facial features. As shown in FIG. 3, in an example embodiment, the visual sensor 374 may include a dedicated hardware processor or microcontroller that can detect these facial patterns to identify presence of a human face via landmarks or other features detected on an image of the user's face and other facial patterns and provide this data as output to, for example, a facial detection module and the video scaler hardware controller 364 within the standalone digital display device. This identification of a human face may take minimal processing or less processing than identification of a user's face from a plurality of facial landmarks or features and comparison with other stored facial patterns to identify user-selected OSD settings from among stored facial profiles for users of the standalone digital display device as described below.

At line 305, the video scaler hardware controller 364 may execute a facial detection module. As described in some embodiments herein, the visual sensor 374 may include a dedicated hardware processor or microcontroller that can detect these facial patterns such as landmarks on the user's face and other facial patterns to identify that a human face is before the standalone digital display device and provide this data as output to, for example, the facial detection module and the video scaler hardware controller 364 within the standalone digital display device. Alternatively, the visual sensor may provide image output to the facial detection module and video scaler hardware controller 364 to analyze and define facial landmarks, facial patterns, and other features from image data of the user's face in order to detect the location of the user's face in front of the standalone digital display device. Plural user faces may be detected in front of the standalone digital display device in some embodiments.

At line 307, the method includes detecting those landmarks, at the user's face, used to generate facial patterns of the user's face. This may include identifying any landmarks across the user's face in an embodiment. In an embodiment where multiple faces may be detected in front of the standalone digital display device, a centrally-located user face may be identified or a distance measurement may be taken to select a closest user face in front of the standalone digital display device. The facial landmarks may include, in example embodiments, any points or features of the user's face such as position and shape of the user's eyes, distance between the user's eyes, specific points of the user's eyes such as the corner of the eyes, eyebrow shape, location, outer and inner corners of the user's eyebrows, relative angle to the user's eyes, location of the user's nose features such as the tip, bridge and nostrils, location of the user's mouth features such as the corners, center of lips, and upper and lower lip boundaries, locations and features of the user's chin, jawline, and cheekbones, location of the user's forehead, location of the user's ears, and the location of each of these features relative to each other. Each or any of these landmarks may be used, in an embodiment, during execution of computer readable code instructions of a facial recognition algorithm of the facial recognition module to identify a specific user and are unique to each potential user using the standalone digital display device. Again, during operation, the video scaler hardware controller 364 may execute, along with the computer-readable program code instructions of the facial detection module, any facial recognition software algorithm that identifies these landmarks for generation of the facial pattern of each user detected in images in front of the standalone digital display device.

The method includes, at line 309, the video scaler hardware controller 364 executing computer-readable program code instructions of the facial detection module to generate a facial pattern. As described, this unique facial pattern may define each or any of the detected landmarks in the image of the user's face and, as such, the collection of a plurality of those detected facial landmarks are unique to that individual user. Regardless, if the user is a new user of the standalone digital display device or a returning user, the facial detection module may conduct this process every time the visual sensor has detected a user present in front of the standalone digital display device from a captured image.

At line 311, the method of FIG. 3 includes comparing, with the video scaler hardware controller 364, the facial pattern of the user's face to any of a plurality of facial patterns stored on a scaler memory device 372 for a plurality of users that use the standalone digital display device. The scaler memory device 372 may be operatively coupled to the video scaler hardware controller 364 on-board the standalone digital display device and may be formed onto a scalar board in some embodiments. As described herein, the standalone digital display device includes a scaler memory device 372 used to store a plurality of facial patterns associated with plural users for later use by the video scaler hardware controller and the on-screen display settings module. This enables the standalone digital display device to be used, with customized settings, by any plurality of users and operably coupled to plural information handling systems providing video data without each user needing to go into display settings on each information handling system to set and automatically apply the on-screen display (OSD) settings to received video data when the standalone digital display device swaps users or swaps operatively coupled information handling systems 300.

In an embodiment, those computer readable code instructions of facial recognition algorithms used with the facial detection module to identify facial landmarks and develop the facial patterns of the user may also be used to compare any new facial pattern of a newly detected user to those facial patterns already stored in the scalar memory device 372. For example, the LBPH algorithm may be used to compare and analyze pixel patterns within a captured image for a returning user or within an image with new facial pattern for a new user to pixel patterns of those facial patterns stored in the scalar memory device 372. Other computer readable code instructions of facial recognition algorithms used with the facial detection module to identify facial landmarks and develop the facial patterns of the user may include convolutional neural network (CNN)-based algorithms for analyzing or comparing facial pattern vectors within a captured image for a returning user or within an image with new facial pattern for a new user to pixel patterns of those facial patterns stored in the scalar memory device 372. It is appreciated that other comparison processes may be conducted, and the present specification contemplates the use of those other facial recognition algorithm comparison processes or a combination of processes in order to identify if the facial pattern for a user in front of the standalone digital display device matches any of the facial patterns stored on the scalar memory device 372 or is a new facial pattern of a new user.

At line 313, however, there may be instances where no matched facial profiles have been found among the plurality of facial patterns for facial profiles stored on the scalar memory device 372 indicating a new user. This may be a result of the detected user using the standalone digital display device for the first time or that the user's facial pattern was deleted from the scalar memory device 372 as described in embodiments herein. Regardless of the reason why a facial pattern saved on the scalar memory device 372 does not match the new user's generated facial pattern, the video scalar hardware controller 364 may begin the process of creating a new facial pattern and associated user-selected OSD settings for a facial profile for the new user within the saved facial patterns and facial profiles on the scalar memory device 372. The video scaler hardware controller 364 may begin this process by saving the new facial pattern on the scalar memory device 372.

At line 315, the process of generating a new facial pattern and associated user-selected OSD settings for a facial profile for the new user may continue with the video scaler hardware controller 364 executing computer-readable program code instructions of the OSD settings module 370 to open an OSD settings GUI. As described herein, this GUI depicts the options available for the OSD settings available to the user for selection. This OSD settings GUI is presented to the user by the scaler hardware processor on a display screen panel of the standalone digital display device. These OSD settings selections may include, for example, image brightness levels, image contrast levels, audio levels (where built-in speakers are present), image color settings, frame rates, and the selection of predefined modes and configurations such as a HDR mode, a gaming mode, a preferred input source, a screen theme, and the like for how the standalone digital display device operates with received video data. The OSD settings GUI presenting the OSD settings may require that the user provide inputs as to how to, if at all, to adjust the OSD settings and/or accept the OSD settings as they are currently constituted on the standalone digital display device.

At line 317, the method also includes those user-selected OSD settings to be transmitted to the video scaler hardware controller 364, with time and date stamp data for the detected new user facial profile, so that those user-selected OSD settings may be stored on the scalar memory device 372 and associated with the new facial pattern of the new user in a new user facial profile saved on the scalar memory device 372. As described herein, this process may be conducted once for a given user such that the video scaler hardware controller 364 does not need to require the user to manually input changes to meet the user's customized user-selected OSD settings again when the standalone video display device is swapped between user's and/or operatively coupled information handling system 300. Recognition of the user by the visual sensor and facial detection module before the standalone digital display device causes those selected OSD settings to be applied automatically to received video data from any operatively coupled information handling system to display image on its display screen panel.

The method further includes, at line 319 where a stored facial pattern has been matched with the facial pattern detected by the visual sensor 374, the execution of the computer-readable program code instructions of the facial detection module by the video scaler hardware controller 364 may identify those user-selected OSD settings associated with the matched facial pattern and its facial profile stored in the scaler memory device 372 to be automatically selected for application. In an embodiment, the video scaler hardware controller 364 executes computer-readable program code instructions of a profile bridging firmware module to interface with the OSD settings of the standalone digital display device to have those OSD settings identified for application during the operation of the standalone digital display device. This may, in some embodiments, affect the how the video scaler hardware controller 364 processes video input received from the operatively coupled information handling system 300 to determine how a TCON processes this video data for display at the display screen panel.

Proceeding to line 321, the video scaler hardware controller 364 may apply predefined facial profile storage policies set for the standalone digital display device. This may include requiring authentication by a new user when a newly facial pattern is detected in captured images that does not correspond to a stored user facial pattern. For example, a new user may be required to enter a code, password, or provide some other authentication before the video scaler hardware controller 364 executes computer-readable program code instructions of a profile bridging firmware module to store a new facial pattern and establish a new user facial profile via an OSD settings GUI and accepting new user-selected OSD settings.

In other embodiments, predefined facial profile storage policies set for the standalone digital display device may include limitations on user count for the standalone digital display device. In an example embodiment, a predefined facial profile storage policies set for the standalone digital display device may include a limit on the number of users that may access user-selected OSD settings automatically on the standalone digital display device. Once a limit on the number of user facial profiles stored in the scaler memory device 372 is reached, any new facial profiles of a newly detected user's face may cause an overwrite of the oldest stored user facial profile in the scaler memory device 372 in an embodiment. In such an embodiment, a date and time stamp may be recorded for creation of a user facial profile or for a last use of a user facial profile that is stored in the scaler memory device 372 with each of the plurality of user facial profiles, their facial patterns, and user-selected OSD settings to determine which user facial profile to overwrite. In other embodiments, a first-in last out buffer may be maintained for each of the stored user facial profiles based on recency of usage.

In yet other embodiments, predefined facial profile storage policies set for the standalone digital display device may include limitations on age with an expiry date for user facial profile availability on the standalone digital display device. For example, a predefined facial profile storage policies set for the standalone digital display device may include a limit on how long it has been since a user has accessed user-selected OSD settings automatically on the standalone digital display device. Once an user facial profile age threshold of a number days since the user facial profiles stored in the scaler memory device 372 has been used this may cause a delete of the expired stored user facial profiles from the scaler memory device 372 in an embodiment. In such an embodiment as well, a date and time stamp may be recorded for creation of each user facial profile or for a last use of each user facial profile that is stored in the scaler memory device 372 with the plurality of user facial profiles, their facial patterns, and user-selected OSD settings to identify expired user facial profiles.

Proceeding to line 323, video data is received from an operatively coupled information handling system 300 at the video scaler hardware controller 364 of the standalone digital display device. Such video data may be generated by a GPU or other processor pursuant to executing software or firmware at the information handling system 300 for generating images for that software or firmware. However, in embodiments herein, automatic application of customized, user-selected OSD settings keyed to each of a plurality of stored user facial profiles operates on the standalone digital display device independent of the operatively coupled information handling system 300 supplying the video data for presenting images on the standalone digital display device and overrides any display settings received from the information handling system 300 in embodiments herein. The video data may be received from any information handling system operatively coupled with the standalone digital display device but may be customized at the standalone digital display device with user-selected OSD settings before display based on the detected user's facial pattern and associated stored facial profile according to embodiments herein.

At line 325, the method includes automatically applying those user-selected OSD settings associated with the user identified before the standalone digital display device from a stored or newly created user's facial profile. The user-selected OSD settings associated with the identified user's facial profile is automatically applied to the video data input received from the operatively-coupled information handling system by the standalone digital display device. In an embodiment, the user-selected OSD settings are automatically applied via the video scaler hardware controller 364 executing computer-readable program code instructions of the profile bridging firmware module to automatically apply the user-selected OSD settings without the OSD settings module 370 being required to open up the OSD settings GUI and require a user to provide changes input to any settings or for the user to go into a display settings control on an operating system (OS) executing on the operatively coupled information handling system 300 to change the display settings. It is appreciated that, however, if a user does not like current user-selected OSD settings automatically applied from the user's stored facial profile, the user may access the OSD settings at the standalone digital display device and make additional changes with the video scaler hardware controller 364. In embodiments herein, this may update automatically or with confirmation from the user, the user-selected OSD settings stored with the user's facial profile that has been associated with the user's facial pattern on the scalar memory device 372.

At line 327, the method may also include the video scaler hardware controller 364 monitoring for the disappearance of the user in front of the standalone digital display device. In an embodiment, the visual sensor 374 may continuously monitor for and detect an absence of a user, or at least identification of a human face which may take less processing, in front of the visual sensor 374 of the standalone digital display device. When an absence is detected, the visual sensor 374 may continue to monitor for and detect the return of a presence of a human face which may be the previous user or a new user. The visual sensor 374 may then recapture images of the returning user's to determine the facial patterns of that user to identify the returning user or a new user. In an embodiment, after the visual sensor 374 has detected the absence of the user for a period of time above an absence threshold time period, such as for 10 seconds in one example, the visual sensor 374 may proceed to look for and detect user-presence of any human face in front of the standalone digital display device. Any absence threshold period of time is contemplated in embodiments herein depending on desired sensitivity or security. This may be done so that the scalar hardware controller 364 executes the processes and methods described herein (e.g., lines 303 through 313) for identification of a particular user's facial profile only when it has been determined that the user has stepped away from the standalone digital display device and, potentially, that same user or a new user later tries to use the standalone digital display device. Operation of the standalone digital display device pursuant to the identified user-selected OSD settings may otherwise continue as long as the human face is continued as detected without interruption or an absence threshold time period has not expired. This latter human presence detection may take less processing than identification of a user facial pattern and association with a facial profile for an identified user.

At line 329, the method includes the standalone digital display device and its video scaler hardware controller 364 determining shutdown to the standalone digital display device. If at line 329, the digital display device is still initiated, the system may return to lines 325 through 329 to automatically apply user-selected OSD settings to received video data based on the currently determined user facial profile or to monitor for absence of the current user from before the standalone digital display device. Further, it is appreciated that those processes described in connection with lines 303 through 329 or 325 through 329 may be repeated any time the video scaler hardware controller detects the absence of a user in front of the standalone digital display device until power to the standalone digital display device has been turned off.

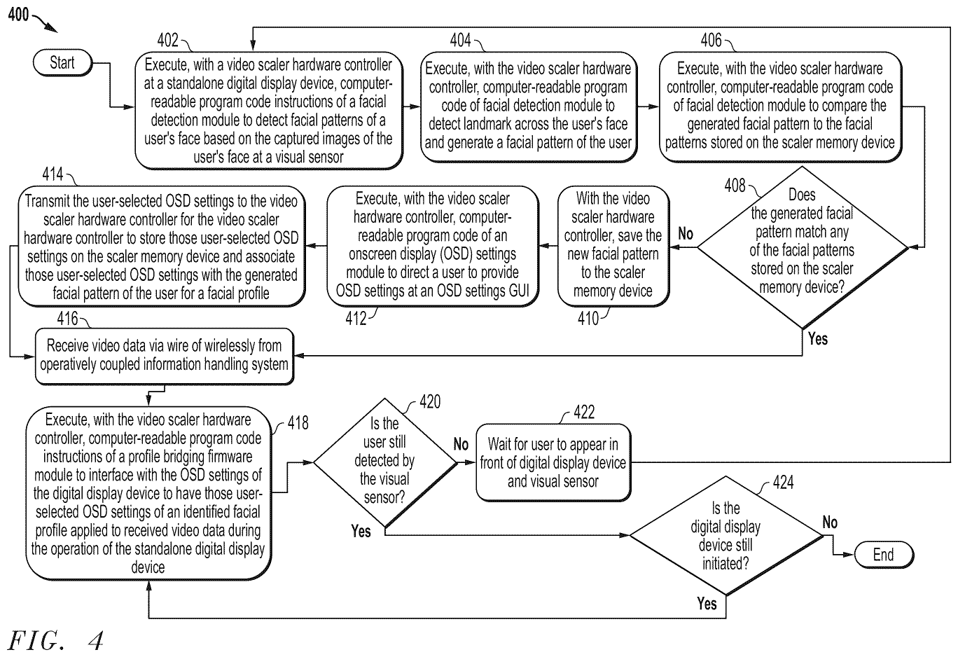

FIG. 4 is a flow diagram showing a method of executing computer-readable program code instructions for automatically setting OSD settings according to another embodiment of the present disclosure. The method 400 described in connection with FIG. 4 may be operated on a standalone digital display device such as the standalone digital display device (e.g., 150, 250) described in connection with FIG. 1 or 2.

The method 400 includes, at block 402 executing, with a video scaler hardware controller, computer-readable program code instructions of a facial detection module to detect facial patterns of a human face for a user based on the captured images of the user's face at a visual sensor. As described herein, a visual sensor integrated on-board the standalone digital display device or as a peripheral device coupled to the standalone digital display device may be used to capture, at least, a portion of a user's face and identify it as a human face detected within the frame of the visual sensor. In an embodiment, the visual sensor of the standalone digital display device may include a dedicated hardware processor or microcontroller that can detect these facial patterns such as landmarks on the user's face and other facial patterns and provide this data as output to, for example, the facial detection module executing at the visual sensor microcontroller or at the video scaler hardware controller within the standalone digital display device. This identification of a human face may take minimal processing or less processing than identification of a user's face from a plurality of facial landmarks or features and comparison with other stored facial patterns to identify user-selected OSD settings from among stored facial profiles for users of the standalone digital display device as described below. The visual sensor may provide image output to the facial detection module, and the video scaler hardware controller may analyze and define facial landmarks, facial patterns, and other features of the user's face in order to detect the location of the user's face in front of the standalone digital display device in an example embodiment. In either example, at least a portion of the user's face is captured and analyzed to identify these facial patterns of the user's face and define landmarks on the user's face. In an embodiment, the visual sensor may be a camera or some type of time-of-flight (ToF) visual sensor. In an embodiment, the visual sensor may be an imaging device that can capture either or both a two-dimensional image or a three-dimensional image of the user's face. In an embodiment, the visual sensor may be an RGB camera that captures color images of the user's face, an IR camera that captures depth and thermal information from the user's face, a ToF camera that measures the three-dimensional shape of the user's face and images of the user's face, a LIDAR that measures the three-dimensional shape of the user's face, and/or an ultrasonic sensor that measures the three-dimensional shape of the user's face. In an embodiment, the visual sensor that is part of the standalone digital display device may implement one or a plurality of these technologies in order to capture one or more images of the user's face as the user moves within the frame of the visual sensor. The standalone digital display device is a display device that is intended to be used with one or more of a plurality of wired or wirelessly operatively coupled information handling systems to display images pursuant to video data received from the operatively coupled information handling system. The standalone digital display device may be swapped out with any individual operatively coupled information handling system or may be used by any of a plurality of users with an operatively coupled information handling system in various embodiments herein.

At block 404, the method 400 also includes executing, with the video scaler hardware controller, computer-readable program code of the facial detection module to detect landmarks across the user's face and generate a facial pattern of the user. This facial pattern may include identification of facial landmarks, distances of those landmarks, and relative locations of those facial landmarks that are unique to the user and be used to identify the user. As the visual sensor, in real-time, captures the images of the user's face, this output from the visual sensor is provided to a facial detection module for further processing in an embodiment. Again, the facial detection module may be integral to the visual sensor with a microcontroller or other hardware processor of the visual sensor executing the machine-readable program code instructions of the facial detection module on-board the standalone digital display device and independent of the operatively coupled information handling system to detect facial patterns of a user's face based on those captured images of the user's face at the visual sensor. Again, in an alternative embodiment, the facial detection module may be executed by the video scaler hardware controller formed on, for example, a scaler board within the standalone digital display device and operating independently to any operatively coupled information handling system.

As described herein, execution of the computer-readable program code instructions of the facial detection module may, in an embodiment, detect facial landmarks of the user's face within the facial patterns to identify a user from other facial patterns of other users. These landmarks may include, for example, any points or features of the user's face such as position and shape of the user's eyes, distance between the user's eyes, specific points of the user's eyes such as the corner of the eyes, eyebrow shape, location, outer and inner corners of the user's eyebrows, relative angle to the user's eyes, location of the user's nose features such as the tip, bridge and nostrils, location of the user's mouth features such as the corners, center of lips, and upper and lower lip boundaries, locations and features of the user's chin, jawline, and cheekbones, location of the user's forehead, location of the user's ears, and the location of each of these features relative to each other. In an example embodiment, the facial recognition system uses these landmarks as anchor points for mapping the geometry and proportions of a face. In an embodiment, the scaler hardware controller 164 may execute any type of algorithm to identify landmarks on a user's face and develop a facial pattern for that user. These facial recognition algorithm may include any convolutional neural network such as MobileNet® developed by Google®, FaceNet® developed by Google®, a visual descriptor such as LBPH or OpenCV by Intel®, and Eigenface among other algorithms. MobileNet® may be designed for process resource-constrained devices (e.g., those including lower power devices) such as the standalone digital display device 150 and may have a relatively high accuracy of 99%. Eigenface may be suitable for basic facial recognition tasks that are easy to implement with OpenCV and may have a moderate level of accuracy with sensitivities to lighting and facial expressions. Eigenface also requires a relatively low computational resources and could be executed by the video scaler hardware controller of the standalone digital display device. FaceNet may be relatively accurate but may require relatively higher computational resources. In an embodiment, therefore, where FaceNet® is used, the standalone digital display device may interface with the information handling system to execute this facial recognition algorithm in order to develop a facial pattern of a user. LBPH may also be highly accurate with low computation resource consumption and may be executed by the video scaler hardware controller on the standalone digital display device.

The method 400 also includes, at block 406, the video scaler hardware controller may execute the computer-readable program code instructions of the facial detection module to compare the currently available facial pattern detected by the visual sensor and defined by the facial detection module to those facial patterns and OSD settings sets of facial profiles stored on-board the standalone digital display device in the scaler memory device. As described herein, the user detected by the visual sensor may be a new user using the standalone digital display device or may be a previous user whose facial pattern has been stored already on the scaler memory device.

As such, at block 408, the method 400 includes determining if the generated facial pattern matches any of the facial patterns stored on the scalar memory device. As described herein, the comparison may be completed with the video scalar hardware controller executing computer-readable program code instructions of one or more facial pattern algorithms previously used to identify facial landmarks and develop the facial patterns described herein. For example, the LBPH algorithm may be used to compare and analyze pixel patterns within the new facial pattern to pixel patterns of those facial patterns stored in the scalar memory device. Other CNN-based algorithms may be used by comparing facial pattern vectors of the new facial pattern to facial pattern vectors of each of the facial patters stored on the scalar memory device 372. It is appreciated that other comparison processes may be conducted, and the present specification contemplates the use of those other comparison processes in order to identify if the new facial pattern describing the user in front of the standalone digital display device matches any of the facial patterns stored on the scalar memory device.

Where no facial patterns stored on the scalar memory device match the new generated facial pattern, the method 400 continues to block 410. At block 410, the method 400 includes the video scaler hardware controller saving the new facial pattern to the scalar memory device. As described herein, the scalar memory device may contain a plurality of sets of facial patterns and user-selected OSD settings that are specific to operation of the standalone digital display device used by a plurality of users to have user-specific OSD settings automatically applied to received video data from a user's operatively coupled information handling system when the visual sensor and facial detection module determine that the user is a returning user.

The method 400 further includes, at block 412, executing computer-readable program code of an OSD settings module with the video scaler hardware controller to direct a user to provide OSD settings at an OSD settings GUI. The OSD settings GUI may include a security requirement or code to allow the new user to input her user-selected OSD settings to operate the shared digital display device. For example, an authorized new user may have been given a Again, this GUI associated with the OSD settings module shows available options for the user to manipulate to change various OSD settings for operation of the standalone digital display device and which are applied to incoming video data from operatively coupled information handling systems. These OSD settings may include standalone digital display device specific setting such as, for example, image brightness levels, image contrast levels, audio levels (where built-in speakers are present), image color settings, frame rates, and the selection of predefined modes and configurations such as a HDR mode, a gaming mode, a preferred input source, a screen theme, and the like. The GUI presenting the OSD settings may also require that the user provide inputs as to how to, if at all, adjust the OSD settings and/or accept the OSD settings as they are currently constituted.

At block 414, these user-selected OSD settings may be transmitted to the video scalar hardware controller for the video scalar hardware controller to store those user-selected OSD settings on the scalar memory device and associate those user-selected OSD settings with the generated facial pattern of the user as part of a facial profile for the user. This creates an individualized set of facial pattern and associated OSD settings in the facial profile for the new user for current and later use by the video scalar hardware controller to automatically apply those user-selected OSD settings.

At block 416, the standalone digital display device may receive video data via wired coupling or wireless coupling to the operatively coupled information handling system. This video data is generated pursuant to execution of software or firmware code instructions at the operatively coupled information handling system that operates independently from but with the standalone digital display device. A GPU or other hardware processing resource generates the video data including settings or values, such as pixel values, for display at a display screen panel at the standalone digital display device. Further, the video data may include audio data such as for soundtracks, sounds, alerts or others audio sounds for play at one or more on-board speakers at the standalone digital display device in embodiments. Additionally, video data from the operatively coupled information handling system may include standalone digital display device settings set at the information handling system. The systems of the embodiments herein, automatically apply the user-selected OSD settings at the standalone digital display device for a facial profile of a user on top of the video data received and superseding any settings received from the operatively coupled information handling system.

At block 418, the method 400 includes executing, with the video scalar hardware controller, computer-readable program code instructions of a profile bridging firmware module to interface with the OSD settings of the standalone digital display device to have those user-selected OSD settings applied to the operation of the standalone digital display device. Again, this may, in some embodiments, affect the how the video scaler hardware controller processes video data input received from the operatively coupled information handling system and determines how a TCON of the standalone digital display device processes this video data at the display panel, or a combination of both. Upon detecting an individualized user facial pattern and associating it with a facial profile for a user, new or previously stored, the associated OSD settings for the facial profile are automatically applied by the video scalar hardware controller during use of the standalone digital display device to receive video data from an operatively coupled information handling system and automatically display images according to those user-selected OSD settings in the facial profile. The user-selected OSD settings pursuant to each of the plurality of facial profiles stored is automatically applied to the incoming video data and overrides or is applied on top of any display settings set at an operatively coupled information handing system. This way, the shared standalone digital display device may apply custom user-selected OSD settings for a plurality of users for the standalone digital display device regardless of the information handling system operatively coupled. For example, two or more users may use the same operatively coupled information handling system with the standalone digital display device and the custom user-selected OSD settings will be applied for each of them. Additionally, plural user's may attach or wirelessly couple a plurality of different information handling systems to the standalone digital display device, yet the video scaler hardware controller will execute the on-board facial detection module and profile bridging firmware module to identify a facial profile or generate one and automatically apply the custom user-selected OSD settings for any of the operatively coupled information handling systems.

It is appreciated that, at block 408, where the user's facial pattern does match with a facial pattern stored on the scalar memory device, those processes at blocks 410 through 414 are not completed and instead those user-selected OSD settings previously reassociated with the stored and matching facial pattern on the standalone digital display device are automatically applied to the operation of the standalone digital display device as described in connection with block 416.

At block 420, the method 400 also includes the visual sensor determining if the user is no longer in front of the standalone digital display device by monitoring for the disappearance of the user. This monitoring process may be a continuous monitoring process or may include intermittingly determining (e.g., block 420) if a human face of the user is detected. In an embodiment, after the visual sensor has detected the absence of the user, via missing facial patterns of a human face in captured images for a period of time above an absence threshold time period such as for 10 seconds, the visual sensor may proceed to monitor for and detect user-presence, in the form of searching for new facial patterns by the on-board facial detection module, in front of the standalone digital display device. This may be done so that the scalar hardware controller executes the processes and methods described herein to search for a user, identify facial patterns and associate them with stored OSD settings or conduct gathering new OSD settings only when it has been determined that the user has stepped away from the standalone digital display device and, potentially, a new user later tries to use the standalone digital display device. Operation of the standalone digital display device pursuant to the identified user-selected OSD settings may otherwise continue as long as the human face continues to be detected without interruption or an absence threshold time period has not expired. This latter human presence detection may take less processing than identification of a user facial pattern and association with a facial profile for an identified user to select associated user-selected OSD settings for the user according to embodiments herein.

Where the user or any other user is no longer detected, the method 400 continues to block 422 with the visual sensor waiting for a user, or more specifically a human face to appear in front of the standalone digital display device and visual sensor. As described herein, the visual sensor may detect a user and the method 400 may continue again at block 402 with, once detected, the visual sensor and facial detection module on-board the standalone digital display device detecting facial patterns of a human face of the user based on the captured images of the user's face at a visual sensor when a user is detected. Where the user is still detected at block 420, however, the method continues to block 424.

At block 424, the method 400 includes determining if the standalone digital display device is still initiated. Where the standalone digital display device is still initiated, the method 400 proceeds to block 418 with the video scalar hardware controller applying those user-selected OSD settings to received video data during the operation of the standalone digital display device as described herein. Where the information handling system is no longer initiated, the method 400 may end here.

The blocks of the flow diagrams of FIGS. 3 and 4 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. A standalone digital display device comprising:
a wireless or wired network interface device to receive video data and display settings from an operatively coupled information handling system;
a video scaler hardware controller, a scaler memory device, a timing controller (TCON), a display screen panel, and a power supply unit (PSU) to provide power to the video scaler hardware controller, the scaler memory device, the TCON, and the display screen panel;
a visual sensor on the standalone digital display device to capture images of a user's face;
the video scaler hardware controller to receive the images of the user's face from the visual sensor in a closed loop and to execute computer-readable program code instructions of a facial detection module to detect facial patterns of the user's face detected in front of the standalone digital display device based on the captured images of the user's face;
the video scaler hardware controller to access the scaler storage device at the standalone digital display device to determine if the detected facial patterns of the user's face match a facial pattern stored on the scaler storage device among a plurality of stored facial patterns for a plurality of facial profiles of a plurality of users;
the video scaler hardware controller to execute computer-readable program code of a profile bridging firmware module to, when a matching facial pattern is found, access a facial profile with user-selected on-screen display (OSD) settings associated with the matching facial pattern to automatically apply the user-selected OSD settings of that facial profile to the received video display data to adjust operation of a display screen panel at the standalone digital display device independently of the operatively coupled information handling system; and
the video scaler hardware controller to automatically transmit the video data with the user-selected OSD settings to a timing controller (TCON) to display image and video content at the display screen panel adjusted according to the user-selected OSD settings applied to the video data.

2. The standalone digital display device of claim 1, further comprising:
the video scaler hardware controller to execute computer-readable program code instructions of the facial detection module to detect the facial patterns from captured images of the user's face includes the facial detection module detecting landmarks across the user's face and distances between these landmarks; and
the video scalar hardware controller matching the detected landmarks across the user's face and distances between these landmarks with stored landmarks and distances between these landmarks associated with a stored facial pattern at the scaler memory device.

3. The standalone digital display device of claim 1 further comprising:
the video scaler hardware controller to, when no detected facial patterns of the user's face match any facial pattern stored on the scaler storage device among a plurality of stored facial patterns, store a new detected facial pattern; and
the video scaler hardware controller to presents an OSD graphical user interface (GUI) to the user to receive corresponding new user-selected OSD settings of the standalone digital display device to be associated with the new facial pattern for a new user in a new facial profile and to stores the new facial profile with corresponding new user-selected OSD settings on the scaler storage device.

4. The standalone digital display device of claim 3 further comprising:
the video scaler hardware controller to determine if a count limit of users has been exceeded with the new facial profile and store the new facial profile with a time and date stamp on the scaler storage device; and
the video scaler hardware controller to delete an oldest facial profile from the plurality of facial profiles stored on the scaler storage device.

5. The standalone digital display device of claim 1 further comprising:
the video scaler hardware controller to determine if any facial profile of the plurality of facial profiles stored on the scaler storage device has exceeded a facial profile age threshold based on a time and date stamp for the facial profile stored on the scaler storage device; and
the video scaler hardware controller to delete any facial profile from the plurality of facial profiles stored on the scaler storage device that exceeds the facial profile age threshold.

6. The standalone digital display device of claim 1 further comprising:
the video scaler hardware controller to execute the computer-readable program code instructions of the facial detection module to detect a single face among a plurality of faces of users in front of the visual sensor and select the single face of a single user among the plurality of faces of users to identify the facial profile of the single user and automatically apply the user-selected OSD settings associated with the facial profile of the single user to the received video data from the operatively coupled information handling system.

7. The standalone digital display device of claim 1 further comprising:
the video scaler hardware controller to execute the computer-readable program code instructions of the facial detection module to detect a centrally-located face among a plurality of faces of users in front of the visual sensor from the captures images of the user's face and select the centrally-located face as the user's face to determine facial patterns and select the facial profile for the user-selected OSD settings to apply to received video data from the operatively coupled information handling system.

8. The standalone digital display device of claim 1 further comprising:
the visual sensor to detect an absence of the user in front of the standalone digital display device;
the scaler hardware controller, when absence is detected, to detect a new presence of a second user and receive images of the second user's face to determine the facial patterns of the second user to determine if the second user is a new user or the user previously in front of the standalone digital display; and
the scaler hardware controller to automatically apply the user-selected OSD settings associated with the facial profile of the user to the received video data from the operatively coupled information handling system when the second user is the user returning that was previously in front of the standalone digital display.

9. The standalone digital display device of claim 8 further comprising:
scaler hardware controller to match the facial patterns of the second user with another facial profile of the plurality of facial profiles or determine the second user is a new user and apply the user-selected OSD settings associated with the facial profile of the second user to the received video data from the operatively coupled information handling system when the second user is not the user previously in front of the standalone digital display.

10. A method executing computer-readable program code instructions for automatically applying user-selected on-screen display (OSD) settings for a user of a standalone digital display device comprising:
receiving, via a wireless or wired network interface device, video data and settings from an operatively coupled information system;
capturing images of a user's face with a visual sensor on the standalone digital display device;
executing, with a video scaler hardware controller, computer-readable program code instructions of a facial detection module to detect facial patterns of a user's face based on the captured images of the user's face at the visual sensor;
accessing the scaler storage device on the on the standalone digital display device to determine if the detected facial patterns of the user's face match a facial pattern stored on the scaler storage device among a plurality of stored facial patterns for a plurality of users;
executing, with the video scalar hardware controller, computer-readable program code of a profile bridging firmware module to, when a matching facial pattern is found, access a facial profile with user-selected OSD settings associated with the matching facial pattern to automatically apply the user-selected OSD settings of that facial profile to the received video display data to adjust operation of a display screen panel at the standalone digital display device independently of the operatively coupled information handling system; and
displaying image and video content at a display screen panel of the standalone digital display device adjusted according to the user-selected OSD settings applied to the video data.

11. The method of claim 10 further comprising:
executing, with the video scaler hardware controller, computer-readable program code instructions of the facial detection module to detect the facial patterns includes the facial detection module detecting landmarks across the user's face and distances between these landmarks; and
matching the detected landmarks across the user's face in the facial patterns and distances between these landmarks with stored landmarks and distances between these landmarks associated with the facial pattern stored on the scaler storage device among a plurality of stored facial patterns.

12. The method of claim 10 further comprising:
storing the detected facial pattern, at the scaler storage device when no detected facial patterns of the user's face match a facial pattern stored on the scaler storage device among a plurality of stored facial patterns, as a distinct facial pattern; and
presenting at the display screen panel an OSD settings graphical user interface (GUI) to receive corresponding user selected OSD settings from a new user to be associated with the distinct facial pattern and store the distinct facial patterns and corresponding user-selected OSD settings as a new facial profile on the scaler storage device.

13. The method of claim 12 further comprising:
determining, via the video scaler hardware controller, when a count limit of users has been exceeded with the new facial profile and store the new facial profile with a time and date stamp on the scaler storage device; and
deleting an oldest facial profile from the plurality of facial profiles stored on the scaler storage device based on stored time and date stamps for the facial profiles.

14. The method of claim 10 further comprising:
executing, with the video scaler hardware controller, the computer-readable program code instructions of the facial detection module to detect a single face among a plurality of faces of users in front of the visual sensor; and
selecting the single face of a single user among the plurality of faces of users to apply the user-selected OSD settings congruent with the facial profile associated with the matched facial pattern for the single user stored on the scalar storage device to the video data received at the standalone digital display device.

15. A standalone digital display device comprising:
a wireless or wired network interface device to receive video data and display settings from an operatively coupled information handling system;
a video scaler hardware controller, a scaler memory device, a timing controller (TCON), a display screen panel, and a power supply unit (PSU) to provide power to the video scaler hardware controller, the scaler memory device, the TCON, and the display screen panel;
a visual sensor on the standalone digital display device to capture images of a user's face;
the video scaler hardware controller to receive the images of the user's face from the visual sensor in a closed loop and to execute computer-readable program code instructions of a facial detection module to detect facial patterns of the user's face detected in front of the standalone digital display device based on the captured images of the user's face;
the video scaler hardware controller to access the scaler storage device at the standalone digital display device to determine if the detected facial patterns of the user's face match a facial pattern stored on the scaler storage device among a plurality of stored facial patterns for a plurality of facial profiles of a plurality of users;
the video scaler hardware controller to execute computer-readable program code of a profile bridging firmware module to, when a matching facial pattern is found, access a facial profile with user-selected on-screen display (OSD) settings associated with the matching facial pattern to automatically apply the user-selected OSD settings of that facial profile to the received video display data to adjust operation of a display screen panel at the standalone digital display device independently of the operatively coupled information handling system;
the video scaler hardware controller to, when no detected facial patterns of the user's face match a facial pattern stored on the scaler storage device among the plurality of stored facial patterns, store the detected facial patterns as a distinct facial pattern and presents a OSD settings graphical user interface (GUI) associated to receive the user-selected OSD settings to be associated with the distinct facial pattern for a new user and store the distinct facial patterns and corresponding user-selected OSD settings in a new facial profile for the new user on the scaler storage device; and
the video scaler hardware controller to automatically transmit the video data with the user-selected OSD settings to a timing controller (TCON) to display image and video content at the display screen panel adjusted according to the user-selected OSD settings applied to the video data.

16. The standalone digital display device of claim 15 further comprising:
the video scaler hardware controller to execute the computer-readable program code instructions of the facial detection module to detect a single face among a plurality of faces of users in front of the visual sensor and select the single face of a single user among the plurality of faces of users to apply the user-selected OSD settings congruent with the facial profile associated with the matched facial pattern for the single user stored on the scalar storage device to the video data received at the standalone digital display device.

17. The standalone digital display device of claim 15 further comprising:
the video scaler hardware controller to execute the computer-readable program code instructions of the facial detection module to detect a centrally-located face among a plurality of faces of users in front of the visual sensor and select the centrally-located face of a single user among the plurality of faces of users to apply the user-selected OSD settings congruent with the facial profile associated with the matched facial pattern for the single user stored on the scalar storage device to the video data received at the standalone digital display device.

18. The standalone digital display device of claim 15 further comprising:
the video scaler hardware controller to determine if a count limit of users has been exceeded with the new facial profile and store the new facial profile with a time and date stamp on the scaler storage device; and
the video scaler hardware controller to delete an oldest facial profile from the plurality of facial profiles stored on the scaler storage device based on stored time and date stamps for the facial profiles.

19. The standalone digital display device of claim 15 further comprising:
the video scaler hardware controller to determine if any facial profile of the plurality of facial profiles stored on the scaler storage device has exceeded a facial profile age threshold based on a time and date stamp for the facial profile stored on the scaler storage device; and
the video scaler hardware controller to delete any facial profile from the plurality of facial profiles stored on the scaler storage device that exceeds the facial profile age threshold.

20. The standalone digital display device of claim 15 further comprising
the visual sensor to detect an absence of the user's face in front of the standalone digital display device after the absence of the user's face has been detected for a period of time above an absence threshold time period; and
the visual sensor after detecting an absence of the user's face in front of the standalone digital display device monitoring to detect the presence of the user's face returning by recapturing images to determine the facial patterns of the user's face via execution computer readable code instructions of the facial detection module.
